(19) United States
(12) Patent Application Publication
(10) Pub. No.: US 2024/0253881 A1
(43) Pub. Date: Aug. 1, 2024

(54) Container for the preparation of a liquid foodstuff

(71) Applicant: FluidSolids AG, Zürich (CH)

(72) Inventors: Beat Karrer, Zürich (CH); Angelika Zys, Adliswil (CH); Francesca Tancini, Neuenhof (CH)

(73) Assignee: FluidSolids AG, Zürich (CH)

(21) Appl. No.: 18/566,655

(22) PCT Filed: Jun. 23, 2022
(86) PCT No.: PCT/EP2022/067259

§ 371 Date: Dec. 4, 2023

(30) Foreign Application Priority Data
Jun. 29, 2021 (CH) 00757/21

(51) Int. Cl. B65D 65/46; B65D 85/804

(52) U.S. Cl. CPC B65D 65/466; B65D 85/8043; B65D 2565/381

(57) ABSTRACT

The present application relates to containers for the preparation of a liquid foodstuff with a capsule-shaped body with a cavity open on one side. A powder of the foodstuff is filled into the cavity. Furthermore, the container comprises a lid with which the open side of the cavity is closed. The base body is made of a compostable material. The material comprises 10-90% by weight of at least one protein binder, 2-75% by weight of at least one cellulose material, 0.1-80% by weight of water, 0.3-15% by weight of at least one salt and 0-40% by weight of an additive.

### TECHNICAL AREA

The invention relates to a container for the preparation of a liquid foodstuff, in particular a coffee capsule, which has a capsule-shaped base body made of a compostable material.

### STATE OF THE ART

Containers for the preparation of a liquid foodstuff are known in the prior art, in particular coffee or tea capsules. Such containers contain a powder or extract for preparing the liquid foodstuff. The containers are placed in corresponding machines, by means of which hot water in particular is introduced into the container under pressure in order to brew or prepare the liquid foodstuff from the powder or extract. To introduce the water into the container, it must be pierced or perforated using a device on the machine. The same applies to the discharge of the prepared liquid foodstuff from the container, whereby areas of the container can also be designed in such a way that they burst open due to the pressure of the water introduced to form openings or perforations.

Most of the containers on the market today, especially coffee capsules, are made of aluminum or petroleum-based plastic. They are therefore not recyclable or can only be recycled with considerable effort. In addition, the disposal of such containers has a considerable environmental impact, especially if the containers end up in a landfill or, if disposed of improperly, in nature or in a body of water.

There is therefore great interest in containers for the preparation of liquid foodstuffs that can be disposed of in an environmentally friendly manner.

### DISCLOSURE OF THE INVENTION

The object of the present invention is to provide a container for the preparation of a liquid foodstuff, in particular a beverage, which is produced from natural raw materials and which is biodegradable and preferably also recyclable.

The solution to the problem is defined by the features of claim 1. According to the invention, the container for the preparation of a liquid foodstuff comprises a capsule-shaped body with a cavity open on one side. A powder of the foodstuff is filled in the cavity. Furthermore, the container comprises a lid with which the open side of the cavity is closed. The base body is made of a compostable material. The material comprises 10-90% by weight of at least one protein binder, 2-75% by weight of at least one cellulose material, 0.1-80% by weight of water, 0.3-15% by weight of at least one salt and 0-40% by weight of an additive.

Due to its composition, the material is compostable, whereby it is completely degraded even in household compost. The material can be completely dissolved in the environment or in water, which means that even if used containers are disposed of improperly, there is little or no environmental impact. Surprisingly, it has been shown that the material can withstand extraction conditions, e.g. in a capsule coffee machine, without any problems despite its complete degradability and dissolution in water. Furthermore, depending on its composition, the material is also largely recyclable. It was also found that the material has very good barrier properties, i.e. the material has a low oxygen permeability rate and low water vapor permeability, which means that the container offers good protection against oxidation and moisture for the food powder it contains.

The liquid foodstuff is preferably a coffee beverage such as espresso, tea, cocoa, a chocolate beverage, a milk beverage, infant milk formula, bouillon or soup.

Accordingly, the powder or extract of the foodstuff is preferably coffee powder, powder of tea leaves or extract of tea leaves, cocoa powder, chocolate powder, milk powder, infant milk powder, bouillon powder or soup powder.

The capsule-shaped base body is preferably in the form of a truncated cone, in particular in the form of two truncated cones arranged one above the other. Alternatively, however, the capsule-shaped base body can also be in the form of a cylinder, a hemisphere, a partial ellipsoid or in another suitable form.

The cover is preferably welded or bonded to the base body. It is also preferred that the cover is attached to the base body by a form fit or friction fit. Preferably, a seal, in particular a squeeze seal, is arranged on the cover or the base body.

In the following application, recyclable material is understood to mean a material which can be reprocessed and whose main component(s), in the present case in particular the cellulose material, can then be used as a starting material for the production of new material, for paper, cardboard, paperboard or new containers according to the invention.

The substances contained in the material are completely biodegradable and can therefore be disposed of easily and in an environmentally friendly manner, in particular via waste water or compost. The materials used allow complete degradation of the containers both in household compost and in industrial compost in accordance with the standards of DIN/EN 13432:2000. In addition, the material or a container formed from it is non-hazardously degradable in nature and in water in accordance with the specifications of ISO 16221:2001.

The material exhibits thermoplastic properties during processing, in particular when exposed to heat, and can therefore be processed into containers using the methods known from polymer processing, for example by injection molding, extrusion, pressing, casting, rotational molding or vacuum forming. The material can also be processed into containers by sintering or using a 3D printer.

The cellulose material is preferably in the form of fibers or a powder. If the cellulose material is present as a powder, it has an average particle size of 100-2000 μm, preferably 150-1000 μm, more preferably 250-500 μm.

The cellulose material is preferably present in the material in an amount of 2-90 wt. %, more preferably 5-80 wt. %, particularly preferably 15-60 wt. %, especially preferably 25-50 wt. %.

In the following application, a protein binder is understood to be a protein or a protein mixture that has the properties of an adhesive and can harden. Protein binders can soften when heat is applied and the material can thus be reshaped. By using the at least one protein binder, a thermoplastic behavior of the material according to the invention can thus be achieved.

The at least one protein binder is preferably present in the material in a concentration of 10-90 wt. %, more preferably 20-80 wt. %, particularly preferably 30-70 wt. %.

The material contains 0.1-80 wt.-%, preferably 0.5-60 wt.-%, particularly preferably 1-10 wt.-% of water.

Furthermore, the material comprises 0.3-15% by weight, preferably 1-10% by weight, more preferably 2-6% by weight of at least one salt.

Depending on the application, the material may have at least one additive. The at least one additive can be used to add an additional physical, optical, tactile or chemical property to the material or to specifically change such a property. For example, the material can be colored with a dye or pigments. The at least one additive is preferably biodegradable and/or recyclable.

The material preferably contains up to 25% by weight of shellac as an additive. The addition of shellac can increase the flowability of the material and its cohesion during processing.

Furthermore, the material may comprise at least one alcohol as an additive in an amount of 1 to 20% by weight, in particular 5 to 15% by weight.

The at least one alcohol preferably has 1 to 50 carbon atoms. The alcohol is preferably an alcohol with 2 to 30 carbon atoms, in particular with 2 to 15 carbon atoms.

The at least one alcohol can be linear or branched. The at least one alcohol can be a monohydric alcohol, but is preferably a polyhydric alcohol, in particular with 2 to 15 hydroxy groups, preferably from 2 to 10 hydroxy groups, in particular from 2 to 6 hydroxy groups.

Preferably, the at least one alcohol is selected from polyglycerol-3 (CAS 25618-55-7), glycerol ethoxylate (CAS 316954-55-0), pentaerythriole ethoxylate (CAS 30599-15-6), polyethylene glycol E400 (CAS 25322-68-3), glycerol (CAS 56-81-5), 1,2-propanediol (CAS 57-55-6), dipentaerythritol (CAS 126-58-9), pentaerythritol (CAS 115-77-5), sorbitol (CAS 50-70-4), xylitol (CAS 87-99-0), mannitol (CAS 69-65-8), sucrose (CAS 57-50-1), trehalose (CAS 6138-23-4), ethylene glycol (CAS 107-21-1), diethylene glycol (CAS 111-46-6), triethylene glycol (CAS 112-27-6) or a mixture thereof.

Preferably, the compostable material according to the invention comprises starch, at least one monosaccharide, at least one oligosaccharide or at least one polysaccharide or a mixture thereof as an additive.

Preferably, the additive is selected from wheat starch, potato starch, rice starch, tapioca starch, corn starch, dextrins, agar, alginates, pectins, chitin, cyclodextrins or mixtures thereof. Further preferably, the additive may comprise saccharides from extracts of algae, fruits, vegetables and/or cereals.

Furthermore, glucose, fructose, galactose, sucrose, trehalose, maltose, lactose, maltodextrin, dextrose, isomalt, erythritol, mannitol, xylitol, sugar syrups, invert sugar syrup or a mixture thereof can preferably be used as an additive. Such sugar compounds act as an additional binder in the material, which can increase the strength of the compostable material or allow to reduce the amount of at least one protein binder while maintaining the same strength of the material.

At least one ester may also be present in the material as an additive. The at least one ester is preferably a carboxylic acid ester and preferably has from 2 to 22 carbon atoms, in particular from 6 to 12 carbon atoms. The at least one ester may be a monoester, but is preferably a polyester. In particular, the at least one ester is preferably an alkyl citrate or glycerol acetate, preferably triethyl citrate (CAS 77-93-0) or glycerol triacetate (CAS 102-76-1).

The material preferably comprises a preservative as an additive. The preferably used preservative is ascorbic acid or citric acid or salts thereof, a sorbate, plant extracts or a mixture thereof.

Preferably, the material comprises at least one animal or vegetable fat as an additive. The addition of a fat can improve the granulation of the material during processing. The at least one fat used can be linseed oil, castor oil, rapeseed oil, sunflower oil, fat powder, medium-chain triglycerides or a mixture thereof.

The material also preferably comprises at least one natural wax, in particular carnauba wax, candelilla wax, sugar cane wax, beeswax or stearin or a mixture thereof as an additive.

The at least one additive can preferably be a flavoring or flavoring extract, in particular vanillin.

Preferably, at least one colorant or at least one color pigment is used as an additive, in particular charcoal, an iron oxide, calcium carbonate, a vegetable colorant, preferably from a vegetable or a fruit, e.g. beet or carrot.

The container according to the invention is preferably inserted into a machine intended for this purpose, in particular a coffee capsule machine, whereby the liquid foodstuff, in particular coffee, is prepared or brewed by adding hot water under pressure inside the capsule and then dispensed into a cup or the like. To introduce the hot water, the base body of the container is preferably perforated by a corresponding device of the machine. For dispensing, the lid of the container can be perforated or burst open in a controlled manner by the pressure, e.g. by interacting with a so-called pyramid plate of the machine. Furthermore, the base body and/or the lid may already have corresponding perforations.

Preferably, the lid comprises the same material as the base body. This means that all components of the container are compostable. In addition, the production of the container can be simplified, as only one material is required to produce all the components of the container.

Alternatively, the lid can also be made of a different material. Preferably, the other material is also compostable. In particular, the lid can preferably be made of paper, a non-woven fabric or a biodegradable plastic, such as polylactide.

Furthermore, the lid can also consist of a mixture of the compostable material of the base body with at least one other material or have a layered structure, whereby at least one layer consists of the compostable material of the base body.

Preferably, the lid is attached to the base body by means of a squeeze seal. This makes it easy to manufacture the container and guarantees a high sealing effect between the base body and the lid.

The squeeze seal is preferably made of the same material as the base body. This means that all components of the container are compostable and preferably recyclable. If the lid is also made of the same material, the production of the container can be simplified, as only one material is required to produce all the components of the container.

Preferably, the base body and/or the lid has at least one sealing ring and/or a sealing lip, with which a sealing effect can be achieved between the container and a wall of a receiving space of a machine for preparing the liquid foodstuff. The at least one sealing ring and/or the at least one sealing lip is preferably made of the same material as the base body.

The at least one sealing ring or the at least one sealing lip preferably protrudes from the base body or the cover. The at least one sealing ring or the at least one sealing lip is preferably formed in one piece with the base body or the cover.

Preferably, the lid has a large number of perforations. This allows the brewed or prepared liquid food to be removed from the container without the lid having to be additionally perforated or otherwise opened. To prevent the extract or powder in the cavity from becoming moist or oxidizing before the liquid food is prepared or brewed, the perforations are preferably sealed with a removable protective film.

The lid preferably has a large number of areas with reduced thickness so that when a predefined pressure is applied in the cavity, these areas burst open to form perforations. As a result, the cavity is tightly sealed before the liquid food is prepared or brewed and the perforations are formed in a controlled and simple manner by introducing pressurized water into the cavity.

Preferably, the base body has a plurality of perforations on one side, which is essentially opposite the open side. This allows water to enter the cavity for preparing or brewing the liquid foodstuff without the base body having to be opened or pierced first. To prevent the extract or powder in the cavity from becoming moist or oxidized before the liquid food is prepared or brewed, the perforations are preferably sealed with a removable protective film.

Preferably, the open side of the cavity is closed with a filter, which is arranged underneath the lid. This means that the filter is located on the side of the lid facing the cavity. The filter is preferably made of paper or fleece. The function of the filter is to prevent the powder or extract from escaping from the container with the prepared or brewed liquid food.

The filter can also be firmly attached to the lid. Alternatively, however, a filter can also be fitted on the side of the lid facing away from the cavity.

The filter is preferably made of the same material as the base body. This means that all components of the container are compostable and preferably recyclable. If the lid or any crush seal is also made of the same material, the manufacture of the container can be simplified, as only one material is required to manufacture all the components of the container.

Preferably, the at least one cellulosic material is selected from fibers or powder of cellulose, hemicellulose, hydroxymethyl cellulose, methyl cellulose, microcrystalline cellulose, lignin, wood, hemp, corn, bamboo, coconut shell, nut shells, coffee bean shells, coffee grounds, cocoa shells, cork, paper, cardboard or a mixture thereof.

Preferably, the at least one protein binder comprises an animal protein binder, in particular gelatine, collagen, glutinous glue, casein, keratin, albumin or milk proteins. The glutinous glue is preferably bone glue, hide glue, rabbit glue, fish glue or a mixture thereof.

The at least one protein binder preferably comprises a vegetable protein binder, in particular a protein binder from cereals, soy, almond, hemp, peas, lupine, pumpkin, cassava, sunflower or a mixture thereof. The cereal is preferably wheat, rye, barley, oats, rice, maize, millet or a mixture thereof. The protein binder is preferably gluten.

Preferably, the material of the base body and possibly of the lid comprises at least one animal protein binder and at least one vegetable protein binder.

The at least one salt is preferably selected from sodium carbonate, calcium carbonate, magnesium carbonate, calcium chloride, magnesium chloride, sodium chloride, calcium hydroxide, magnesium hydroxide, magnesium stearate, magnesium silicate, calcium oxide, magnesium oxide, calcium sulphate, magnesium sulphate, calcium phosphate or a mixture thereof.

Further advantageous embodiments and combinations of features of the invention result from the following detailed description and the entirety of the patent claims.

### BRIEF DESCRIPTION OF THE DRAWINGS

The drawings used to illustrate the embodiment example show:

FIG. 1 a side view of a first embodiment of a container according to the present invention;

FIG. 2 a side view of a second embodiment of a container according to the present invention;

FIG. 3 an embodiment of a container with a sealing lip;

FIGS. 4a-4c different arrangements of sealing lips on the collar of the base body;

FIG. 5 an embodiment of a container according to the invention from the open side;

FIG. 6 the embodiment of the container shown in FIG. 5 with fitted lid.

In principle, identical parts are marked with identical reference signs in the figures.

### Ways to Carry Out the Invention

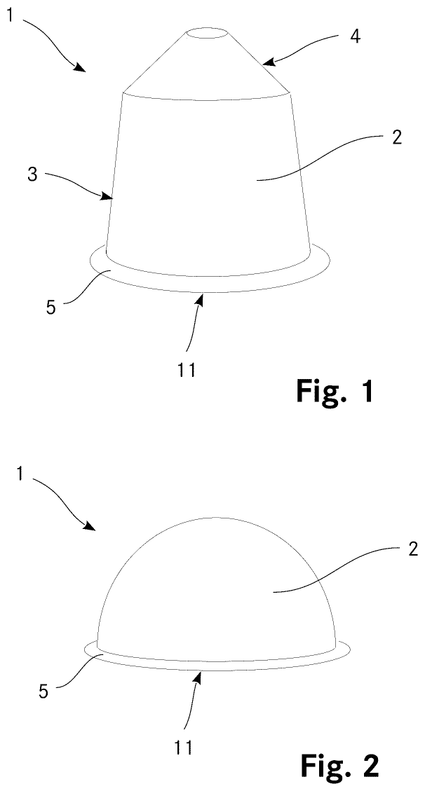

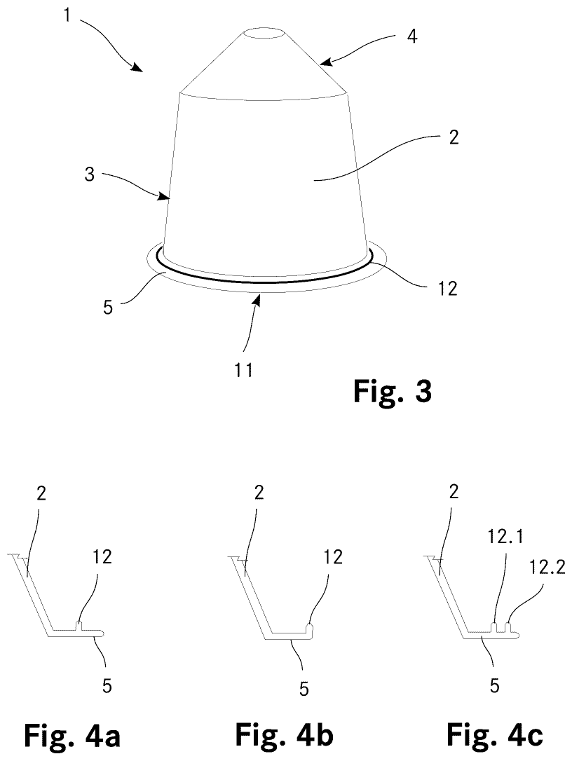

FIG. 1 shows a side view of a first embodiment of a container 1 according to the invention. The container 1 has a capsule-shaped base body 2. In the embodiment shown, the capsule-shaped base body 2 has the shape of two stacked truncated cones 3, 4. A first truncated cone 3 has an open side 11, which is closed by a lid 9 (see FIG. 4), with a circumferential collar 5 extending around the open side 11. On the side of the first truncated cone 3 opposite the open side 11, the base body 2 has a second truncated cone 4. Inside the capsule-shaped base body 2 is a cavity 6 (see FIG. 3), in which a powder or an extract of a liquid foodstuff is filled.

FIG. 2 shows a side view of a second embodiment of a container 1 according to the invention. In contrast to the first embodiment of FIG. 1, the embodiment according to FIG. 2 has a capsule-shaped base body 2 in the form of a hemisphere.

FIG. 3 shows an embodiment of a container 1 with a sealing lip 12, which is arranged on the collar 5. The sealing lip 5 protrudes from the collar 5 and enables a seal between the container 1 and a wall of a receiving chamber of a machine for preparing the liquid beverage, in particular a coffee capsule machine.

FIGS. 4a to 4c show different arrangements of sealing lips 12; 12.1, 12.2 on the collar 5 of the base body 2. In the embodiment according to FIG. 4a, the sealing lip 12 is arranged approximately centrally on the collar 5, whereas in the embodiment according to FIG. 4b, the sealing lip 12 is arranged on the edge of the collar 5. In the embodiment according to FIG. 4c, two sealing lips 12.1, 12.2 are arranged on the collar 5.

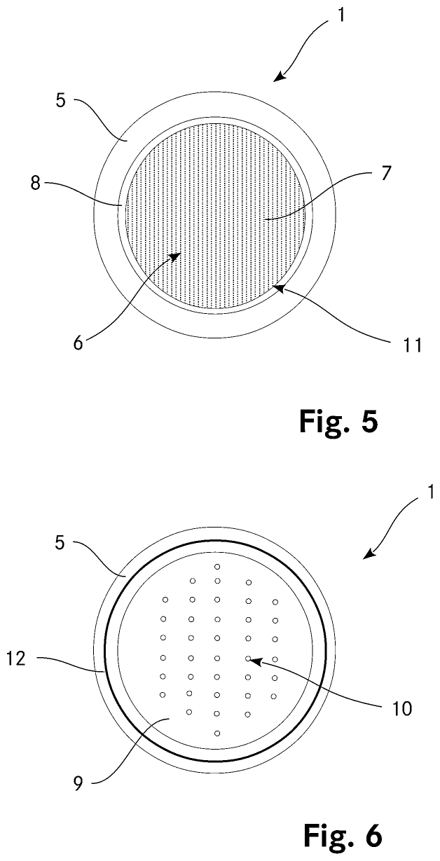

FIG. 5 shows an embodiment of a container 1 according to the invention from the open side 11. The cavity 6 is filled with a powder 7 of a liquid foodstuff. The cavity 6 has a squeeze seal 8 in the area of the open side 11, with which the lid 9 can be fastened.

FIG. 6 shows the embodiment of the container 1 according to FIG. 5 with the lid 9 in place. The lid 9 has a plurality of perforations 10. A liquid beverage prepared or brewed with the container 1 can escape from the container 1 through the perforations 10 without the container having to be pierced or perforated before preparation or brewing. A sealing lip 12 is also arranged on the collar 5.

### EXAMPLE 1

In a first example, 750 g chia flour (with typical nutritional information: 31 wt-% protein, 58 wt*% fiber, 9.5 wt-% fat, <1 wt-% carbohydrates, <1 wt-% salt) was mixed with 63 g coffee fibers (with lengths from 0.1 mm to 0.5 mm) as well as with 6 g citric acid and 7 g calcium oxide in a kettle. 450 g of warm water was added to the previously dry-mixed ingredients and the solution was mixed with a planetary mixer (rotor 10L).

The material was extruded into a strand in a hydraulic press at a pressure of approx. 120 bar through a pressing device consisting of a piston and ram with a nozzle of 2 mm diameter. After hardening, the strand was cut into pieces of 2 mm in length and the resulting granulate was then injection molded into a container.

| | Quantity | |
|---|---|---|
| Component | [g] | Weight % |
| Chia flour | 750 | 58.8 |
| Coffee bean fibers | 63 | 4.9 |
| Citric acid | 6 | 0.5 |
| Calcium oxide | 7 | 0.5 |
| Water | 450 | 35.3 |
| Total | 1276 | 100 |

### EXAMPLE 2

In a second example, 371 g of almond protein flour (with typical nutritional information: 51 wt-% protein, 17 wt-% fiber, 12 wt-% fat, 7 wt-% carbohydrates, <1 wt % salt) was mixed with 199 g of corn meal (with lengths <0.7 mm), 100 g of tragacanth, 94 g of shellac and 4 g of magnesium sulfate in a kettle.

7 g citric acid was dissolved in 400 g warm water. The solution is added to the previously dry-mixed ingredients and mixed with a planetary mixer (rotor 10L).

The material was extruded into a strand in a hydraulic press at a pressure of approx. 120 bar through a pressing device comprising a piston and a plunger with a nozzle of 2 mm diameter. After hardening, the strand was cut into pieces of 2 mm in length and the resulting granulate was then injection molded into a container.

| | Quantity | |
|---|---|---|
| Component | [g] | Weight % |
| Almond protein flour | 371 | 31.6 |
| Corn fibers | 199 | 16.9 |
| Citric acid | 7 | 0.6 |
| Magnesium sulfate | 4 | 0.3 |
| Tragacanth | 100 | 8.5 |
| Shellac | 94 | 8.0 |
| Water | 400 | 34.0 |
| Total | 1175 | 100 |

### EXAMPLE 3

In a third example, 350 g of warm water was mixed with 160 g of rabbit glue and heated to 70° C. in a water bath for 20 minutes to produce the binder component.

40 g albumin was dry mixed with 86 g corn flour, 258 g feed bran fibers, 56 g shellac and 16 g magnesium sulfate in a kettle.

Potassium benzoate was dissolved in 70 g of water. The solution was added to the binder component together with 32 g glycerin. Finally, 16 g of nut oil was added and mixed with a planetary mixer (rotor 10L).

The material was extruded into a strand in a hydraulic press at a pressure of approx. 120 bar through a pressing device comprising a piston and a plunger with a nozzle of 2 mm diameter. After hardening, the strand was cut into pieces of 2 mm in length and the resulting granulate was then injection molded into a container.

| | Quantity | |
|---|---|---|
| Component | [g] | Weight % |
| Rabbit glue | 160 | 18.4 |
| Albumin | 40 | |
| Corn fibers | 86 | 31.7 |
| Feed bran | 258 | |
| Potassium benzoate | 2 | 0.2 |
| Magnesium sulfate | 16 | 1.5 |
| Glycerine | 32 | 2.9 |
| Shellac | 56 | 5.2 |
| Water | 420 | 38.7 |
| Nut oil | 16 | 1.5 |
| Total | 1086 | 100 |

### EXAMPLE 4

In a fourth example, 4 g of citric acid was dissolved in warm water (65° C.). The solution was mixed with 144 g of fish glue and heated to 90° ° C. in a water bath for 20 minutes to produce the binder component.

36 g rice starch was dry mixed with 84 g hemp protein flour (with typical nutritional information: 50 wt-% protein, 23 wt-% fiber, 11 wt-% fat, 9.5 wt-% carbohydrates, <1 w-t % salt), 32 g magnesium sulfate, 312 g corn meal and 8 g sugar cane wax in a kettle.

The dry-mixed ingredients were then added to the binder component and 8 g safflower oil and 24 g glycerine were added. The solution was then mixed thoroughly using a planetary mixer (rotor 10L).

The material was extruded into a strand in a hydraulic press at a pressure of approx. 120 bar through a pressing device comprising a piston and a plunger with a nozzle of 2 mm diameter. After hardening, the strand was cut into pieces of 2 mm in length and the resulting granulate was then injection molded into a container.

| | Quantity | |
|---|---|---|
| Component | [g] | Weight % |
| Fish glue | 144 | 27.7 |
| Hemp protein flour | 84 | |
| Rice starch | 36 | |
| Corn meal | 312 | 32.8 |
| Citric acid | 4 | 0.4 |
| Magnesium sulfate | 32 | 3.4 |
| Glycerine | 24 | 2.5 |
| Sugar cane wax | 8 | 0.8 |
| Water | 300 | 31.5 |
| Safflower oil | 8 | 0.8 |
| Total | 952 | 100 |

We claim:

1-13. (canceled)

14. A container for the preparation of a liquid foodstuff comprising:
a capsule-shaped base body with a cavity open on one side, into which cavity a powder or extract of the foodstuff is filled, and
a lid with which the open side of the cavity is closed,
wherein the base body is made of a compostable material, the compostable material comprising:
10-90% by weight of at least one protein binder;
2-75% by weight of at least one cellulose material;
0.1-80% by weight water;
0.3-15% by weight of at least one salt;
0-40% by weight of an additive.

15. The container according to claim 14, wherein the lid comprises the same compostable material as the base body.

16. The container according to claim 14, wherein the lid is fastened to the base body by means of a squeeze seal.

17. The container according to claim 14, wherein the base body or the lid has at least one sealing ring or at least one sealing lip, with which a sealing effect is achieved between the container and a wall of a receiving space of a machine for preparing the liquid foodstuff.

18. The container according to claim 14, wherein the lid has at least one perforation.

19. The container according to claim 14, wherein the lid has at least one area with a reduced thickness, so that when a predefined pressure is applied in the cavity, this at least one area bursts open to form at least one perforation.

20. The container according to claim 14, wherein the base body has a plurality of perforations on a side which is substantially opposite the open side.

21. The container according to claim 14, wherein the open side of the cavity is closed with a filter which is arranged below the lid.

22. The container according to claim 21, wherein the filter is made of the same compostable material as the base body.

23. The container according to claim 14, wherein the at least one cellulose material is selected from fibres or a powder of cellulose, hemicellulose, hydroxymethylcellulose, methylcellulose, microcrystalline cellulose, lignin, wood, hemp, maize, bamboo, coconut shell, nut shells, coffee bean shells, coffee grounds, cocoa shells, cork, paper, cardboard or a mixture thereof.

24. The container according to claim 14, wherein the at least one protein binder comprises an animal protein binder.

25. The container according to claim 14, wherein the at least one protein binder comprises a vegetable protein binder.

26. The container according to claim 14, wherein the at least one salt is selected from sodium carbonate, calcium carbonate, magnesium carbonate, calcium chloride, magnesium chloride, sodium chloride, calcium hydroxide, magnesium hydroxide, magnesium stearate, magnesium silicate, calcium oxide, magnesium oxide, calcium sulphate, magnesium sulphate, calcium phosphate or a mixture thereof.

27. The container according to claim 26, wherein the animal protein binder is selected from at least one of glutin glue, gelatine, collagen, keratin, casein, albumin or milk proteins.

28. The container according to claim 27, wherein the vegetable protein binder is selected from at least one of cereals, soy, almond, hemp, peas, lupine, pumpkin, cassava, sunflower or a mixture thereof.

29. The container according to claim 14, wherein the liquid foodstuff is beverage.
